(19) United States
(12) Patent Application Publication
(10) Pub. No.: US 2010/0027245 A1
(43) Pub. Date: Feb. 4, 2010

(54) LIGHTING DEVICE FOR DISPLAY DEVICE AND DISPLAY DEVICE

(75) Inventor: Shiyoshi Cho, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/524,178

(22) PCT Filed: Nov. 21, 2007
(86) PCT No.: PCT/JP2007/072537

§ 371 Date: Jul. 23, 2009

(30) Foreign Application Priority Data
Mar. 9, 2007 (JP) 2007-060375

(51) Int. Cl. G02F 1/13357; G09F 13/04; H05B 41/24

(52) U.S. Cl. 362/97.2; 362/97.1; 315/246

(57) ABSTRACT

A lighting device for a display device includes a light source and a chassis arranged to cover the light source. Further included is an inverter circuit board that is mounted to the chassis and includes an inverter circuit arranged to supply drive voltage to the light source. The chassis includes an opening section located directly below a portion of or all of the inverter circuit board. Thus, the lighting device for a display device, capable of preventing or suppressing beat tones generated on a lamp housing member, is provided without increasing the thickness of the device and with a simple structure.

### BACKGROUND OF THE INVENTION

1. Field of the Invention

The present invention relates to a lighting device for a display device and a display device including a lighting device.

2. Description of the Related Art

In a display device having non-luminous optical elements as typified by a liquid crystal display device, a backlight device is provided on the backside of a display panel such as a liquid crystal panel, so as to illuminate the display panel (as shown in JP-A-2006-66360, for example).

JP-A-2006-66360 discloses a backlight assembly that includes lamps and a housing member for holding the lamps. In the backlight assembly thus including lamps and a housing member for holding the lamps, beat tones may be generated during dimming control of the lamps, due to the second and third harmonics of a dimming control frequency.

There are various theories as to how the beat tones are generated. For example, one of the theories suggests involvement of current leakage to the housing member from components such as a power source or wiring lines. That is, the beat tones may be generated by vibration of the housing member caused by leakage current from other components.

JP-A-2006-66360 discloses that bulging portions or recessed portions corresponding to the lamps are formed on the housing member in order to prevent current leakage between the lamps and the housing member. However, the beat tones cannot be reduced adequately even according to this construction. Moreover, if bulging or recessed portions are provided, the housing member may be prone to having increased thickness due to the bulging or recessed portions. This is a significant problem where thinning of liquid crystal display devices is required.

### SUMMARY OF THE INVENTION

Accordingly, preferred embodiments of the present invention provide a lighting device for a display device capable of preventing or suppressing beat tones generated on a lamp housing member, without increasing the thickness of the device and with a simple structure. Preferred embodiments of the present invention also provide a high-quality and highly-reliable display device including the lighting device.

A lighting device for a display device according to a preferred embodiment the present invention includes a light source and a chassis arranged to cover the light source. Further included is an inverter circuit board that is mounted to the chassis and includes an inverter circuit arranged to supply drive voltage to the light source. The chassis includes an opening section located directly below the inverter circuit board.

The inventor of preferred embodiments of the present application has repeatedly considered measures for beat tones, and consequently it has been found that leakage current leaking from the inverter circuit supplying drive voltage to the light source contributes to generating beat tones. In view of this, the opening section directly below the inverter circuit board having the inverter circuit is provided on the chassis, and thereby the beat tones can be substantially eliminated. This may be due to major reduction of current leakage from the inverter circuit board to the chassis. That is, when the chassis thus includes an opening section, the distance between the inverter circuit board and the chassis can be infinitely large at the opening section. Accordingly, the leakage current may be substantially eliminated, which is expressed by the following formula (1):

I=2πfεCV=2πfε(S/d)V formula (1)

where “I” is the amount of leakage current, “C” is the stray capacitance, “V” is the potential difference between the inverter circuit board and the chassis, “S” is the area of the chassis, and “d” is the distance between the inverter circuit board and the chassis.

JP-A-2006-66360 discloses a construction, also as a measure against the current leakage, in which bulging portions or recessed portions corresponding to the lamps or light sources are formed on the housing member or chassis. However, the beat tones cannot be sufficiently eliminated when the above bulging or recessed portions are provided as a measure for beat tones. Further, the beat tones also cannot be sufficiently eliminated when bulging or recessed portions positioned directly below the inverter circuit board is provided instead of those positioned to correspond to lamps or light sources. This may be because the slightly longer distance between the inverter circuit board and the chassis, caused by the bulging or recessed portions, fails to result in sufficient elimination of the beat tones. Further, in the construction thus including bulging or recessed portions, the chassis can vibrate at the bulging or recessed portions.

In contrast, according to a preferred embodiment of the present invention, the opening section is provided directly below the inverter circuit board so that the chassis originally has no tangible portion directly below the inverter circuit board. Accordingly, the chassis cannot vibrate at the position directly below the inverter circuit board, and therefore the beat tones are substantially eliminated. That is, preferred embodiments of the present invention include the opening section but not merely as a measure for current leakage. The beat tones are originally generated at an area directly below the inverter circuit board, and therefore the area is removed from the chassis so as to form an opening section in order to achieve elimination of the beat tones. Particularly, preferred embodiments of the present invention contribute greatly to reduction in size of the present lighting device for a display device, because bulges on the chassis, which are generated due to the bulging or recessed portions as in JP-A-2006-66360, are prevented.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view showing the general construction of a liquid crystal display device according to a preferred embodiment of the present invention.

FIG. 2 is a sectional view of the liquid crystal display device shown in FIG. 1.

FIG. 3 is a perspective view showing the general construction of a chassis included in the liquid crystal display device shown in FIG. 1.

FIG. 4 is a perspective view separately showing sheets and the like to be attached to the chassis.

FIG. 5 is a plan view showing the general construction of the chassis.

FIG. 6 is a schematic plan view showing how an inverter circuit board and a light blocking sheet are mounted to the chassis.

FIG. 7 is a schematic plan view showing a modification of the mounting structure shown in FIG. 6.

FIG. 8 is an explanatory diagram showing a driving scheme for cold cathode tubes, which is applied to the liquid crystal display device shown in FIG. 1.

### DETAILED DESCRIPTION OF THE PREFERRED EMBODIMENTS

Preferred embodiments of the present invention will be hereinafter explained with reference to the drawings.

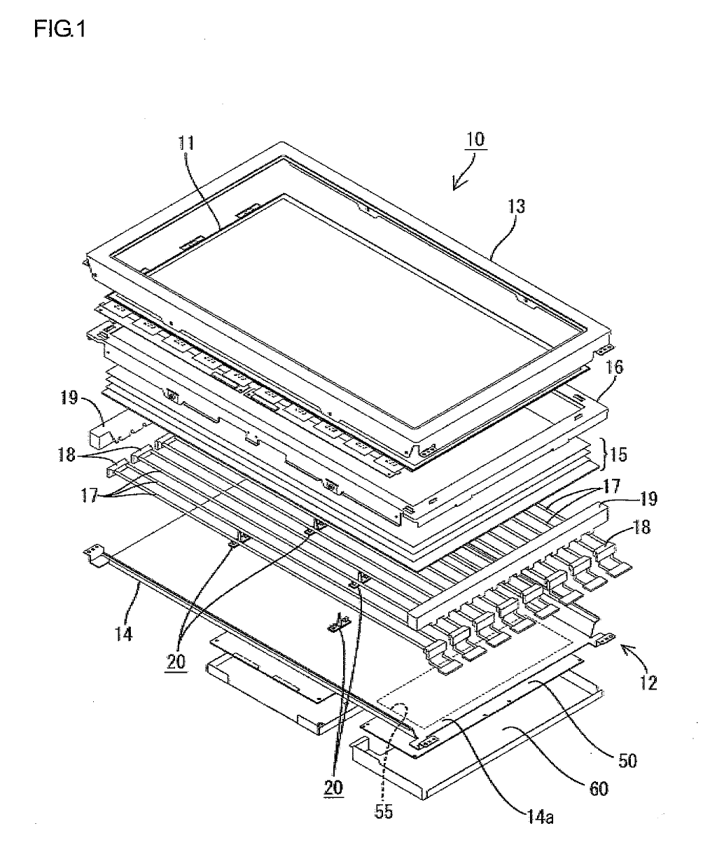

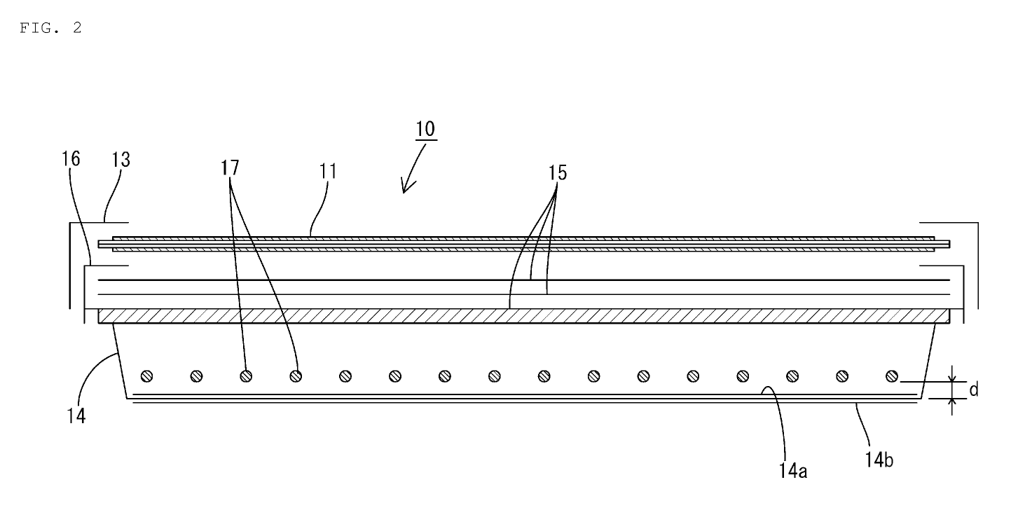

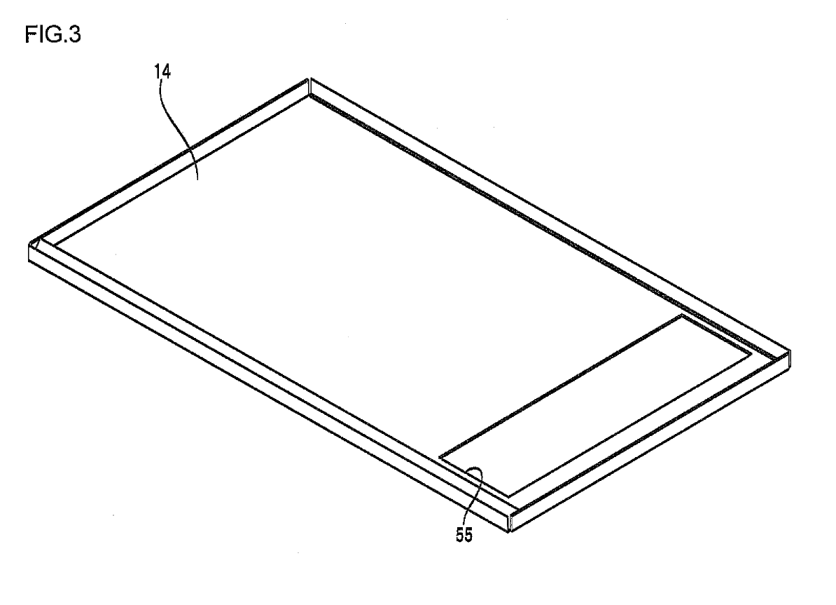

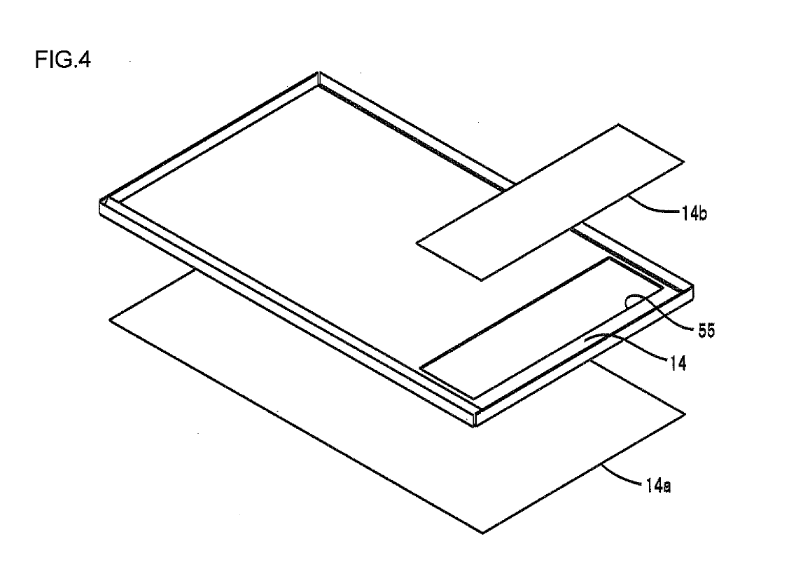

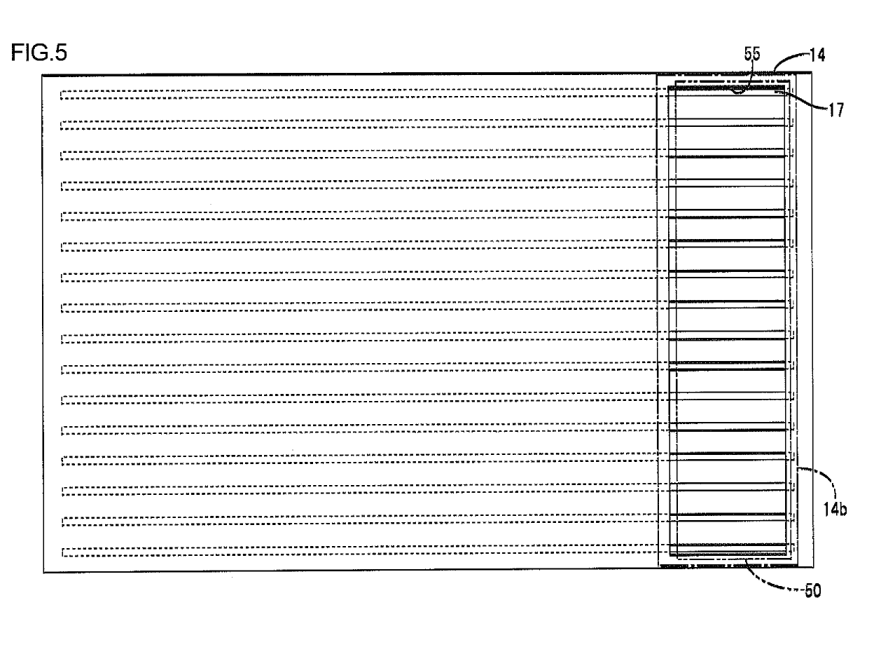

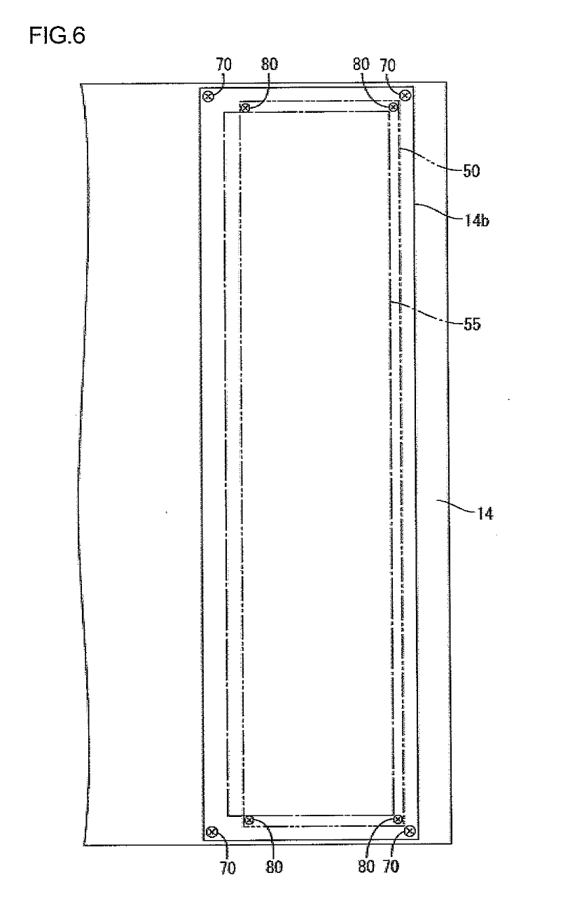

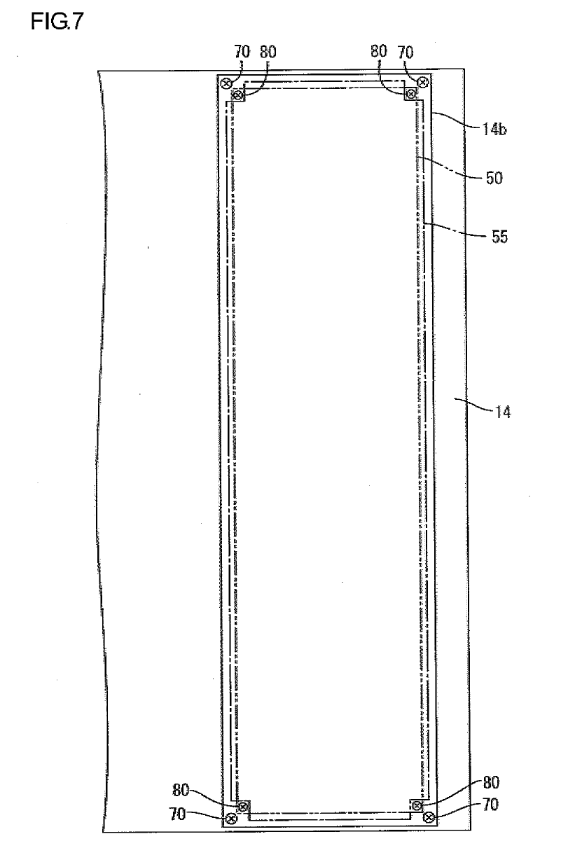

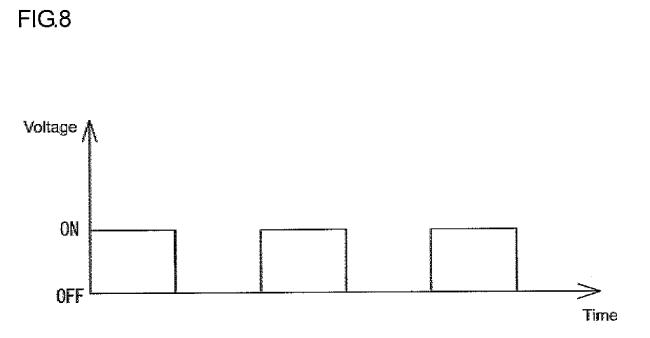

FIG. 1 is an exploded perspective view showing the general construction of a liquid crystal display device according to a preferred embodiment of the present invention. FIG. 2 is a sectional view showing the general construction of the liquid crystal display device. FIG. 3 is a perspective view showing the general construction of a chassis or backlight chassis included in the liquid crystal display device of the present preferred embodiment. FIG. 4 is a perspective view separately showing sheets and the like to be attached to the chassis. FIG. 5 is a plan view showing the general construction of the chassis. FIG. 6 is a schematic diagram showing the construction of a characteristic part of the chassis. FIG. 7 is a schematic diagram showing a modification of the construction of the characteristic portion of the chassis. FIG. 8 is an explanatory diagram showing a driving scheme for cold cathode tubes, which is applied to the liquid crystal display device shown in FIG. 1.

The general construction of the liquid crystal display device 10 according to the present preferred embodiment will be explained first. Referring to FIGS. 1 and 2, the liquid crystal display device 10 includes a liquid crystal panel 11 having a rectangular or substantially rectangular shape, and a backlight device 12 (lighting device for a display device) as an external light source, which are integrally held by a bezel 13 and the like. The liquid crystal panel 11 includes a pair of glass substrates, which are attached to each other so as to face each other while a gap of a predetermined size is kept therebetween. Liquid crystal is sealed between the glass substrates. On one of the glass substrates, components such as switching elements (e.g., TFTs) connected to source wiring lines and gate wiring lines running at right angles to each other, and pixel electrodes connected to the switching elements are provided. On the other of the glass substrates, components such as a counter electrode, a color filter having R, G, and B color sections arranged in a predetermined pattern are provided.

Next, the backlight device 12 will be explained. The backlight device 12 preferably is a so-called direct-light type backlight device that includes a plurality of linear light sources (e.g., cold cathode tubes (tubular light sources) 17 as high-pressure discharge tubes, in the present preferred embodiment), which are positioned directly below the back surface of the liquid crystal panel 11 (i.e., the panel surface on the opposite side of the display side), and are arranged along the panel surface.

The backlight device 12 includes a metallic backlight chassis 14 having a substantially box-like shape with an opening on its upper side, and a plurality of optical members 15 (e.g., a diffuser plate, a diffusing sheet, a lens sheet and an optical sheet, in order from the lower side of the figure) which are arranged to cover in the opening of the backlight chassis 14. Further included are a frame 16 arranged to hold the optical members 15 on the backlight chassis 14, cold cathode tubes (or light sources) 17 contained in the backlight chassis 14, rubber (e.g., silicon rubber) holders 18 arranged to hold the end portions of the cold cathode tubes 17, lamp holders 19 arranged to collectively cover the cold cathode tubes 17 and the holders 18, and lamp clips 20 arranged to mount and hold the cold cathode tubes 17 on the backlight chassis 14. Note that the optical member 15 side of the cold cathode tubes 17 corresponds to the light emitting side of the backlight device 12.

Each of the cold cathode tubes 17 preferably defines a tubular shape elongated in one direction. A number (e.g., sixteen in FIG. 1) of cold cathode tubes 17 are arranged in the backlight chassis 14 so that the longitudinal direction (or axial direction) thereof conforms with the longitudinal direction of the backlight chassis 14. On the other hand, the lamp clips 20, arranged to mount the cold cathode tubes 17 to the backlight chassis 14, function as clip members for holding light sources, and are preferably made of synthetic resin (e.g., polycarbonate). The plurality of lamp clips 20 are mounted on the backlight chassis 14 so as to support each of the cold cathode tubes 17 at two or three points spaced along the longitudinal direction thereof.

The substantially box-like backlight chassis 14 is preferably formed of a metallic plate. A light reflecting sheet 14a is provided on the inner surface side (light source side) of the backlight chassis 14, which defines a light reflecting surface. The backlight chassis 14 thus includes the light reflecting sheet 14a, and thereby the light from the cold cathode tubes 17 can be reflected to the optical members 15 such as the diffuser plate (hereinafter, sometimes referred to as “the diffuser plate 15 and the like”). The light reflecting sheet 14a can be formed of a resin sheet having light reflectivity, for example.

Further, a rectangular-shaped inverter circuit board 50 having an inverter circuit arranged to supply drive voltage to the cold cathode tubes 17 is mounted to the chassis 14. In the present preferred embodiment, the inverter circuit board 50 is preferably arranged on one of the two longitudinal end portions of the chassis 14, and is screwed or fixed to one of the two surfaces of the chassis 14 that is on the opposite side of the cold cathode tubes 17 (or on the opposite side of the light emitting surface).

The inverter circuit provided on the inverter circuit board 50 is an electric circuit that generates a high-frequency voltage for lighting the cold cathode tubes 17. In the present preferred embodiment, the inverter circuit is connected to one of two end portions of each cold cathode tube 17, and therefore the one end portion is subjected to high voltage during lighting. Referring to FIG. 8, in the present preferred embodiment, the cold cathode tubes 17 are driven by pulse-width modulation (PWM), for example. Thereby, the dimming control is performed in a predetermined cycle.

On the chassis 14, an opening section 55 is formed to be located directly below the inverter circuit board 50. The opening section 55 is formed by partially removing the chassis 14, so as to have a rectangular or substantially rectangular shape that conforms to the shape of the inverter circuit board 50 (See FIG. 3). In the present preferred embodiment, the opening section 55 is preferably formed to have a width substantially equal to the width of the inverter circuit board 50, so that it appears to substantially overlap with the inverter circuit board 50 when viewed planarly. The opening section 55 is provided on the inner side of the light reflecting sheet 14a, and therefore is shown by broken lines in FIG. 1. The opening section 55 is preferably made during the sheet processing of the chassis 14, in the present preferred embodiment.

The light reflecting sheet 14a is provided on the inner surface side of the chassis 14 as described above, while a light blocking sheet 14b is provided on the outer surface side of the chassis 14 (i.e., on the back surface side or on the opposite side of the light emitting side) as shown in FIGS. 2 and 4. The light blocking sheet 14b is arranged to cover at least the opening section 55 of the chassis 14, and is screwed or bonded to the chassis 14. The light blocking sheet 14b can be formed of a polycarbonate-resin or acrylic-resin sheet as a molded piece to which lightproof coating material is applied, for example. Further preferably, the light blocking sheet 14b also has resistance to high temperatures, because the cold cathode tubes 17 generate heat.

The inverter circuit board 50 and the light blocking sheet 14b can be mounted to the chassis 14, so as to form a configuration shown in FIG. 6, for example. Specifically, the inverter circuit board 50 is positioned so that it appears to be slightly displaced from the opening section 55 when viewed planarly. The four corners thereof are fixed to the chassis 14 with screws 80, for example. The light blocking sheet 14b is arranged to cover the opening section 55 and the inverter circuit board 50 entirely when viewed planarly. The four corners thereof are fixed to the chassis 14 with screws 70, for example.

The liquid crystal display device 10 thus constructed according to the present preferred embodiment can provide the following operational effects.

In the liquid crystal display device 10 of the present preferred embodiment, the chassis 14 of the backlight device 12 includes an opening section 55 located directly below the inverter circuit board 50. According to the construction, the chassis 14 is less likely to generate beat tones, which can be caused by vibration thereof.

The beat tones generated on the chassis 14 may be caused by vibration of the chassis 14. The vibration may result from various factors, and the factors include current leakage from the inverter circuit board 50.

The chassis 14 is preferably formed of a conductive metal plate, and therefore a capacitor may be formed between the inverter circuit board 50 and the chassis 14. Accordingly, an ordinary construction (not including an opening section 55) may be prone to current leakage to the chassis 14 from the inverter circuit board 50 as a power source for driving the cold cathode tubes 17. A force acting on the chassis 14 can be generated due to the leakage current, which causes the chassis 14 to vibrate resulting in beat tones. Particularly, in the case of pulse-width modulation, the leakage current can be periodic, and therefore a periodic force acts on the chassis 14 so as to generate beat tones.

In contrast, according to the present preferred embodiment, the opening section 55 directly below the inverter circuit board 50 is provided on the chassis 14, so that the possibility of current leakage described above is minimized. Consequently, beat tones can be prevented or suppressed. That is, when the opening section 55 is thus provided, the distance between the inverter circuit board 50 and the chassis 14 can be infinitely large at the opening section 55. Accordingly, the leakage current may be substantially eliminated, which is expressed by the following formula (1):

I=2πfεCV=2πfε(S/d)V formula (1)

where “I” is the amount of leakage current, “C” is the stray capacitance, “V” is the potential difference between the inverter circuit board 50 and the chassis 14, “S” is the area of the chassis 14, and “d” is the distance between the inverter circuit board 50 and the chassis 14.

Particularly, according to the construction in which an opening section 55 is provided directly below the inverter circuit board 50 as in the present preferred embodiment, the chassis 14 cannot vibrate at the positions directly below the inverter circuit board 50 because the chassis 14 originally has no tangible portion directly below the inverter circuit board 50. Accordingly, beat tones can be substantially eliminated.

The intensity of beat tones was tested in the liquid crystal display device of the present preferred embodiment (referred to as the present construction) and in a liquid crystal display device (as a comparative construction) having a backlight device 12 that does not include an opening section 55 on the chassis 14. When the dimming control frequency was set to 265 Hz, the measured frequency of beat tones was 530 Hz. At the time, the tone was measured at 18.9 decibels in the liquid crystal display device having the present construction, while the tone was measured at 31.0 decibels in the liquid crystal display device having the comparative construction.

Further, the opening section 55 provided for prevention or suppression of current leakage, as in the present preferred embodiment, enables a simpler construction, compared to providing bulging portions or recessed portions. Prevention of bulges on the chassis 14 is also achieved, which contributes to thinning the backlight device 12 and therefore to thinning the liquid crystal display device 10.

Moreover, in the present preferred embodiment, the light blocking sheet 14b is attached to the chassis 14 so as to cover the opening section 55. Thereby, the light passing through the opening section 55 can be prevented or suppressed. Consequently, the quality reduction of the backlight device 12, and therefore of the liquid crystal display device 10, can be prevented or suppressed.

Shown above is a preferred embodiment of the present invention. However, the present invention is not limited to the preferred embodiment explained in the above description made with reference to the drawings. The following preferred embodiments may be included in the technical scope of the present invention, for example, and further the present invention may be embodied in various forms without departing from the scope of the invention.

In the liquid crystal display device 10 shown in FIG. 1, the light blocking sheet 14b is preferably attached so as to cover the opening section 55. However, an inverter circuit board 50 formed of a lightproof board may be arranged to substantially cover the opening section 55, for example. Thus, the inverter circuit board 50 can be used for prevention or suppression of light passing through the opening section 55, which contributes to reduction in the number of components.

Instead of the mounting structure shown in FIG. 6, the inverter circuit board 50 and the light blocking sheet 14b may be mounted so as to form a configuration shown in FIG. 7, for example. In FIG. 7, lugs for screws are preferably provided at the four corners of the opening section 55 so as to project from the chassis 14 into the opening section 55. While the inverter circuit board 50 is arranged so that the four corners thereof overlap with the lugs when viewed planarly, the inverter circuit board 50 is fixed to the chassis 14 with screws 80, for example. While the light blocking sheet 14b is arranged to cover the opening section 55 and the inverter circuit board 50 entirely when viewed planarly, the four corners thereof are fixed to the chassis 14 with screws 70.

In the above preferred embodiment, the opening section 55 is preferably formed to overlap with a portion of the inverter circuit board 50. However, the opening section 55 may be formed to overlap with the whole of the inverter circuit board 50 or to cover the inverter circuit board 50 entirely. Specifically, the inverter circuit board 50 can be arranged on the inner side of the opening edge of the opening section 55. In order to achieve this arrangement, the inverter circuit board 50 may be arranged on the light blocking sheet 14b, or alternatively, may be arranged on the chassis 14 via additional mounting members, for example.

In the above preferred embodiment, the backlight device is shown for illustrative purposes, in which the inverter circuit board 50 is arranged on one side so as to be located on the side of one end portion of each cold cathode tube 17. However, inverter circuit boards 50 may be provided on both sides. That is, the above construction can be employed on a backlight device 12 in which both end portions of each cold cathode tube 17 are arranged to be subjected to high voltage. In this construction, opening sections 55 can be formed on the chassis 14 so as to be located directly below the respective inverter circuit board 50 provided on the two end portions.

In the above preferred embodiment, cold cathode tubes 17 are used as light sources. However, the present invention can include a construction in which another type of light sources such as hot cathode tubes is used, for example.

In the above preferred embodiment, TFTs are preferably used as switching elements of the liquid crystal display device. However, the present invention can be applied to a liquid crystal display device that uses another type of switching elements than TFTs (e.g., thin-film diodes (TFDs)). Further, the present invention can be applied to a liquid crystal display device for monochrome display, as well as a liquid crystal display device capable of color display.

Moreover, although a liquid crystal display device is shown in the above preferred embodiment, the present invention can be applied to other types of display devices than a liquid crystal type, which use a backlight device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10. A lighting device for a display device, comprising:
a light source;
a chassis arranged to cover said light source; and
an inverter circuit board mounted to said chassis, said inverter circuit board including an inverter circuit arranged to supply drive voltage to said light source; wherein
said chassis includes an opening section located directly below said inverter circuit board.

11. A lighting device for a display device as in claim 10, wherein said inverter circuit includes an electric circuit arranged to generate a high-frequency voltage as said drive voltage.

12. A lighting device for a display device as in claim 10, wherein:
said inverter circuit board has a rectangular or substantially rectangular shape; and
said opening section has a rectangular or substantially rectangular shape that conforms to the rectangular or substantially rectangular shape of said inverter circuit board.

13. A lighting device for a display device, as in claim 10, wherein a light-blocking sheet is attached to said chassis so as to cover said opening section.

14. A lighting device for a display device, as in claim 10, wherein said inverter circuit board is made of a lightproof board.

15. A lighting device for a display device, as in claim 10, wherein said inverter circuit uses pulse-width modulation to supply said drive voltage to said light source.

16. A lighting device for a display device, as in claim 10, wherein said chassis is made of a metallic plate.

17. A display device comprising:
a lighting device for a display device, as in claim 10; and
a display panel for providing display by use of light from said lighting device for a display device.

18. A display device as in claim 17, wherein said display panel is a liquid crystal panel that uses liquid crystal.
